(19) United States
(12) Patent Application Publication
(10) Pub. No.: US 2026/0288380 A1
(43) Pub. Date: Sep. 24, 2026

(54) Memory controller circuit and operation method thereof

(71) Applicant: REALTEK SEMICONDUCTOR CORPORATION, HSINCHU (TW)

(72) Inventors: YUN-TENG CHENG, HSINCHU (TW); YA-MIN CHANG, HSINCHU (TW); YI LU, HSINCHU (TW); DONG FANG, SUZHOU (CN)

(21) Appl. No.: 19/562,008

(22) Filed: Mar. 10, 2026

(30) Foreign Application Priority Data
Mar. 21, 2025 (CN) 202510344099.5

(51) Int. Cl. G06F 3/06

(52) U.S. Cl. CPC G06F 3/0659; G06F 3/0604; G06F 3/0673

(57) ABSTRACT

A memory controller circuit is provided. A data writing circuit stores a data writing command and write data. A data reading circuit stores a data reading command. A comparison circuit compares a read address and a write address to determine that a data hazard condition occurs when the data read command is later than the data write command and the read address and the write address are the same. The data reading circuit receives the write data as the read data when the data hazard condition occurs without transmitting the data reading command to the memory circuit. The data writing circuit sets a data hazard flag to be a hazard state to prevent a storage space corresponding to the data writing command from being overwritten and sets the data hazard flag to be a non-hazard state after the data writing command is finished being processed.

### BACKGROUND OF THE INVENTION

### 1. Field of the Invention

The present invention relates to a memory controller circuit and a memory controller circuit operation method thereof having a data forwarding mechanism.

### 2. Description of Related Art

When a processor accesses a memory, a plurality of types of data hazards may occur, in which the data hazards may affect the execution order of commands or stop the execution of commands. For example, when a command is writing data that a subsequent command requires to read, the data hazard may occur. Such a data hazard may stop the data transmission and decrease the efficiency of the data transmission.

### SUMMARY OF THE INVENTION

In consideration of the problem of the prior art, an object of the present invention is to supply a memory controller circuit and a memory controller circuit operation method thereof.

The present invention discloses a memory controller circuit configured to access a memory circuit that includes a data writing circuit, a data reading circuit and a comparison circuit. The data writing circuit stores a data writing command and write data and sets a data hazard flag corresponding to a storage space of the data writing command. The data reading circuit stores a data reading command. The comparison circuit compares a read address of the data reading command and a write address of the data writing command to determine that a first timing of the data reading command is later than a second timing of the data writing command and the read address and the write address are the same so as to determine that a data hazard condition occurs. The data reading circuit, in response to the occurrence of the data hazard condition, receives the write data from the data writing circuit as read data and does not transmit the data reading command to the memory circuit. The data writing circuit, in response to the occurrence of the data hazard condition, sets the data hazard flag to be a hazard state to prevent the storage space from being overwritten and sets the data hazard flag to be a non-hazard state after the data writing command is finished being processed such that the write data is written into the memory circuit.

The present invention also discloses a memory controller circuit operation method configured to access a memory circuit that includes steps outlined below. A data writing command and write data are stored and a data hazard flag corresponding to a storage space of the data writing command is set by a data writing circuit. A data reading command is stored by a data reading circuit. A read address of the data reading command and a write address of the data writing command are compared by a comparison circuit to determine that a first timing of the data reading command is later than a second timing of the data writing command and the read address and the write address are the same so as to determine that a data hazard condition occurs. In response to the occurrence of the data hazard condition, the write data is received from the data writing circuit as read data and the data reading command is not transmitted to the memory circuit by the data reading circuit. In response to the occurrence of the data hazard condition, the data hazard flag is set to be a hazard state to prevent the storage space from being overwritten and the data hazard flag is set to be a non-hazard state after the data writing command is finished being processed and the write data is written into the memory circuit by the data writing circuit.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a computer system according to an embodiment of the present invention.

FIG. 2A illustrates a block diagram of the memory controller circuit according to an embodiment of the present invention.

FIG. 2B illustrates a block diagram of the data writing circuit according to an embodiment of the present invention.

FIG. 2C illustrates a block diagram of the data reading circuit according to an embodiment of the present invention.

FIG. 3 illustrates a timing diagram of signals on a plurality of signal paths related to the operation of the memory controller circuit according to an embodiment of the present invention.

FIG. 4 illustrates a timing diagram of signals on a plurality of signal paths related to the operation of the memory controller circuit according to an embodiment of the present invention.

FIG. 5 illustrates a flow chart of a memory controller circuit operation method according to an embodiment of the present invention.

### DETAILED DESCRIPTION OF THE PREFERRED EMBODIMENTS

An aspect of the present invention is to provide a memory controller circuit and a memory controller circuit operation method thereof having a data forwarding mechanism to receive write data from a data writing circuit as read data when a data hazard condition occurs to avoid the condition that a data reading command is hold in order to process a data writing command first occurs and to avoid a read/write turnaround condition occurs. The delay caused by these conditions can be minimized to improve the read/write efficiency of a memory controller circuit.

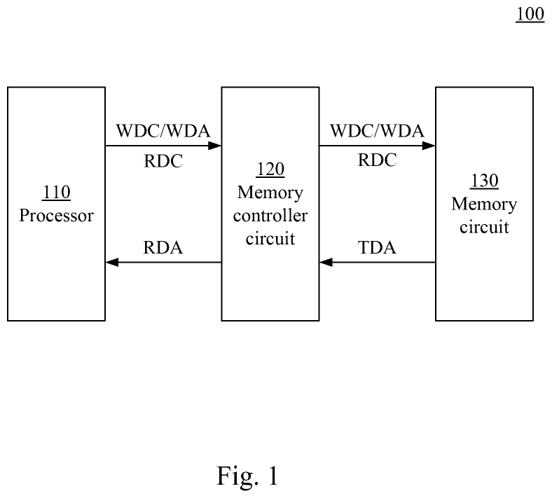

Reference is now made to FIG. 1. FIG. 1 illustrates a block diagram of a computer system 100 according to an embodiment of the present invention. The computer system 100 includes a processor 110, a memory controller circuit 120 and a memory circuit 130.

The memory circuit 130 can be such as but not limited to a dynamic random access memory (DRAM) to store data. The memory controller circuit 120 can be electrically coupled to the processor 110 through a bus such that the processor 110 accesses the memory circuit 130 through the memory controller circuit 120.

The access performed on the memory circuit 130 includes a data writing operation and a data reading operation. Corresponding to the data writing operation, the memory controller circuit 120 receives, processes and transmits a data writing command WDC and write data WDA from the processor 110 to the memory circuit 130 to perform data writing. The memory circuit 130 stores the write data WDA according to a write address included in the data writing command WDC. Corresponding to the data reading operation, the memory controller circuit 120 receives a data reading command RDC from the processor 110 to perform data reading on the memory circuit 130 according to a read address included in the data reading command RDC to set the returned data TDA from the memory circuit 130 to be read data RDA and transmit the read data RDA to the processor 110.

In some applications, the memory controller circuit 120 can only perform one of the data writing operation and the data reading operation on the memory circuit 130 at a time. Under such a condition, when the processor 110 issues the data writing command WDC corresponding to a specific address and issues the data reading command RDC corresponding to the same specific address subsequently within a short amount of time, the condition that the memory controller circuit 120 processes the data reading command RDC first such that old data instead of new data (the data that the data writing command WDC is writing) is read may occur. Such a condition is called data hazard (more specifically, a read-after-write (RAW) hazard).

In order to prevent the data access efficiency from decreasing due to the operation performed when the data hazard occurs, in which the memory controller circuit 120 stops to execute the data reading command RDC in order to process the data writing command WDC first, the memory controller circuit 120 may be equipped with a data forwarding mechanism in the present invention to not only avoid the occurrence of the data hazard but also maintain the data transmission efficiency. The configuration and operation of the memory controller circuit 120 having the data forwarding mechanism are described in the following paragraphs.

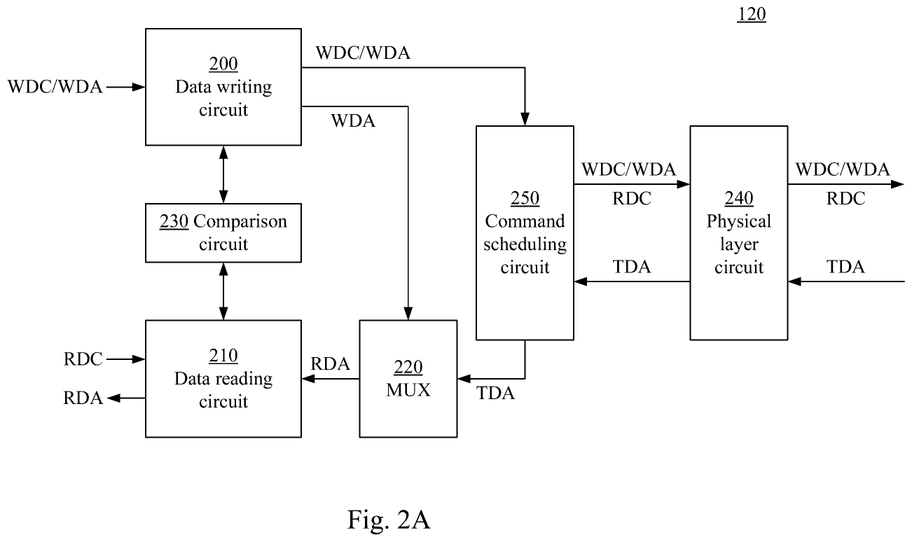

Reference is now made to FIG. 2A. FIG. 2A illustrates a block diagram of the memory controller circuit 120 according to an embodiment of the present invention. The memory controller circuit 120 includes a data writing circuit 200, a data reading circuit 210, a data reading multiplexer 220 (abbreviated as MUX in FIG. 2A), a comparison circuit 230, a physical layer circuit 240 and a command scheduling circuit 250.

The data writing circuit 200 stores the data writing command WDC and the write data WDA corresponding to each other and sets a data hazard flag DHF corresponding to a storage space of the data writing command WDC.

Reference is now made to FIG. 2B at the same time. FIG. 2B illustrates a block diagram of the data writing circuit 200 according to an embodiment of the present invention. As illustrated in FIG. 2B, the data writing circuit 200 includes a command storage circuit 202, a data storage circuit 204 and a processing circuit 206.

In response to the receiving of the data writing command WDC and the write data WDA from the processor 110 in FIG. 1, the processing circuit 206 stores the data writing command WDC in the command storage circuit 202 and stores the write data WDA in the data storage circuit 204. In an embodiment, each of the command storage circuit 202 and the data storage circuit 204 is such as but not limited to a static random access memory (SRAM), a register or other memories that operate without an additional control circuit.

The storage space to store the data writing command WDC is a part of the command storage circuit 202. More specifically, the command storage circuit 202 may include a plurality of storage units (not illustrated in the figure), in which the storage space to store the data writing command WDC is one of the storage units. The processing circuit 206 sets the data hazard flag DHF corresponding to the storage space. In an embodiment, the data hazard flag DHF can be stored in the storage space itself.

The data hazard flag DHF is used to indicate whether a data hazard condition occurs to the data writing command WDC stored in the storage space. In an embodiment, the processing circuit 206 may set the data hazard flag DHF to be a hazard state to indicate the occurrence of the data hazard condition or set the data hazard flag DHF to be a non-hazard state to indicate the non-occurrence of the data hazard condition.

The hazard state and the non-hazard state may be represented by a state of a bit, which is either 0 or 1. For example, the processing circuit 206 may set the data hazard flag DHF to be 1 to represent the hazard state and may set the data hazard flag DHF to be 0 to represent the non-hazard state. However, the present invention is not limited thereto.

It is appreciated that in FIG. 2B, only one group of the data writing command WDC and the write data WDA corresponding to each other is exemplarily illustrated. In practice, the command storage circuit 202 and the data storage circuit 204 may simultaneously store a plurality of groups of the data writing command WDC and the write data WDA corresponding to each other.

On the other hand, the data reading circuit 210 stores the data reading command RDC.

Reference is now made to FIG. 2C at the same time. FIG. 2C illustrates a block diagram of the data reading circuit 210 according to an embodiment of the present invention. As illustrated in FIG. 2C, the data reading circuit 210 includes a command storage circuit 212, a data storage circuit 214 and a processing circuit 216.

In response to the receiving of the data reading command RDC, the processing circuit 216 stores the data reading command RDC in the command storage circuit 212. In response to the receiving of the read data RDA, the processing circuit 216 stores the read data RDA in the data storage circuit 214 for the processor 110 in FIG. 1 to retrieve. In an embodiment, each of the command storage circuit 212 and the data storage circuit 214 is such as but not limited to a static random access memory, a register or other memories that operate without an additional control circuit.

The data reading multiplexer 220 is electrically coupled to the data writing circuit 200, the command scheduling circuit 250 and the data reading circuit 210 to select one of the data writing circuit 200 and the command scheduling circuit 250 as the source of the read data RDA according to the operation of the comparison circuit 230 described below to transmit the read data RDA to the data reading circuit 210.

It is appreciated that in FIG. 2C, only one group of the data reading command RDC and the read data RDA corresponding to each other is exemplarily illustrated. In practice, the command storage circuit 212 may store a plurality of data reading commands RDC and the data storage circuit 204 may simultaneously store a plurality of pieces of read data RDA.

The comparison circuit 230 is electrically coupled to the data writing circuit 200 and the data reading circuit 210 to retrieve and compare a read address of the data reading command RDC and a write address of the data writing command WDC to determine that a first timing of the data reading command RDC is later than a second timing of the data writing command WDC and the read address and the write address are the same so as to determine that a data hazard condition occurs. On the contrary, the comparison circuit 230 determines that the first timing of the data reading command RDC is not later than the second timing of the data writing command WDC or determines that the data writing command WDC and the read address and the write address are not the same so as to determine the data hazard condition does not occur. The data writing circuit 200 and the data reading circuit 210 operate according to the comparison result of the comparison circuit 230.

In an embodiment, the comparison circuit 230 can be an independent circuit or can be implemented by the processing circuit 206 of the data writing circuit 200. Each time the data reading circuit 210 receives the data reading command RDC, the comparison circuit 230 retrieves the data reading command RDC to be compared with the data writing command WDC stored in the data writing circuit 200.

The physical layer circuit 240 is electrically coupled to the memory circuit 130. The command scheduling circuit 250 is configured to perform the data writing operation and the data reading operation on the memory circuit 130 through the physical layer circuit 240.

The performance of the data writing operation is not related to whether the data hazard condition occurs or not. As a result, when the command scheduling circuit 250 performs the data writing operation, the processing circuit 206 of the data writing circuit 200 retrieves and transmits the data writing command WDC and the write data WDA from the command storage circuit 202 and the data storage circuit 204 to the command scheduling circuit 250. The command scheduling circuit 250 performs the data writing on the memory circuit 130 through the physical layer circuit 240 according to the data writing command WDC and the write data WDA to write the write data WDA to a location of the memory circuit 130 corresponding to the write address in the data writing command WDC.

On the contrary, the performance of the data reading operation is related to whether the data hazard condition occurs or not. The processing circuit 216 of the data reading circuit 210 retrieves and transmits the data reading command RDC from the command storage circuit 212 to the command scheduling circuit 250 in response to the data writing operation performed by the command scheduling circuit 250 and the non-occurrence of the data hazard condition. The command scheduling circuit 250 performs the data reading on the memory circuit 130 through the physical layer circuit 240 according to the data reading command RDC without the occurrence of the data hazard condition.

According to the data reading performed on the memory circuit 130, the command scheduling circuit 250 further transmits the returned data TDA received from the memory circuit 130 through the physical layer circuit 240 to the data reading circuit 210. The transmission of the returned data TDA can be performed through the data reading multiplexer 220. More specifically, the data reading multiplexer 220 selects the command scheduling circuit 250 when the data hazard condition does not occur to receive the returned data TDA from the memory circuit 130 as the read data RDA such that the data reading circuit 210 receives and stores the read data RDA in the data storage circuit 214.

In response to the occurrence of the data hazard condition, the data reading circuit 210 receives the write data WDA from the data writing circuit 200 as the read data RDA and does not transmit the data reading command RDC to the memory circuit 130. More specifically, according to the comparison result of the comparison circuit 230, the processing circuit 216 of the data reading circuit 210 may not transmit the data reading command RDC to the memory circuit 130 and the data reading multiplexer 220 selects the data writing circuit 200 to receive the write data WDA as the read data RDA in response to the occurrence of the data hazard condition such that the data reading circuit 210 receives and stores the read data RDA in the data storage circuit 214.

On the other hand, according to the comparison result of the comparison circuit 230, the processing circuit 206 of the data writing circuit 200 may set the data hazard flag DHF to be the hazard state in response to the occurrence of the data hazard condition to prevent the storage space of the data writing command WDC from being overwritten, and set the data hazard flag to be a non-hazard state after the data writing command WDC is finished being processed and the write data WDA is written into the memory circuit 130.

In response to the occurrence of the data hazard condition, the data reading circuit 210 directly receives the write data WDA from the data writing circuit 200 before the write data WDA is actually written to the memory circuit 130 based on the data forwarding mechanism described above. As a result, the data hazard flag DHF that is set to be the hazard state prevents the data writing circuit 200 from overwriting the data writing command that corresponds to the occurrence of the data hazard condition upon receiving a new data writing command. The write data WDA is guaranteed to be actually written to the memory circuit 130. The consistency of the data writing and the data reading can be maintained.

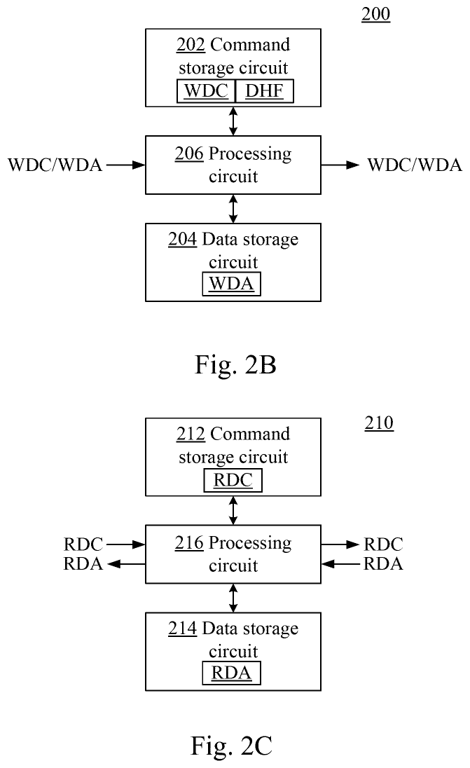

Reference is now made to FIG. 3. FIG. 3 illustrates a timing diagram of signals on a plurality of signal paths related to the operation of the memory controller circuit 120 according to an embodiment of the present invention.

In FIG. 3, besides the clock signal CLK used as a reference of the timing, a command path COM between the command scheduling circuit 250 and the memory circuit 130 that includes the physical layer circuit 240 and a connection wire, a data path DAT between the command scheduling circuit 250 and the memory circuit 130 that includes the physical layer circuit 240 and a connection wire and a data path DAP between the processor 110 and the data reading circuit 210 that includes a connection wire are in turn illustrated.

FIG. 3 illustrates a scenario that the data hazard condition occurs when the command scheduling circuit 250 performs the data writing operation. Under such a condition, the command scheduling circuit 250 keeps controlling the physical layer circuit 240 to perform the data writing on the memory circuit 130 without being affected by the occurrence of the data hazard condition. As a result, the command path COM keeps transmitting data writing commands 300 and the data path DAT keeps transmitting write data 310.

When the data hazard condition is determined to occur at a timing corresponding to the first data writing command 300 in FIG. 3, the data path DAP has the read data 320 transmitted based on the data forwarding mechanism. As a result, even if the command scheduling circuit 250 is performing the data writing operation, the data reading circuit 210 can obtain the required data from the data writing circuit 200 through another path in response to the occurrence of the data hazard condition without affecting the data writing operation.

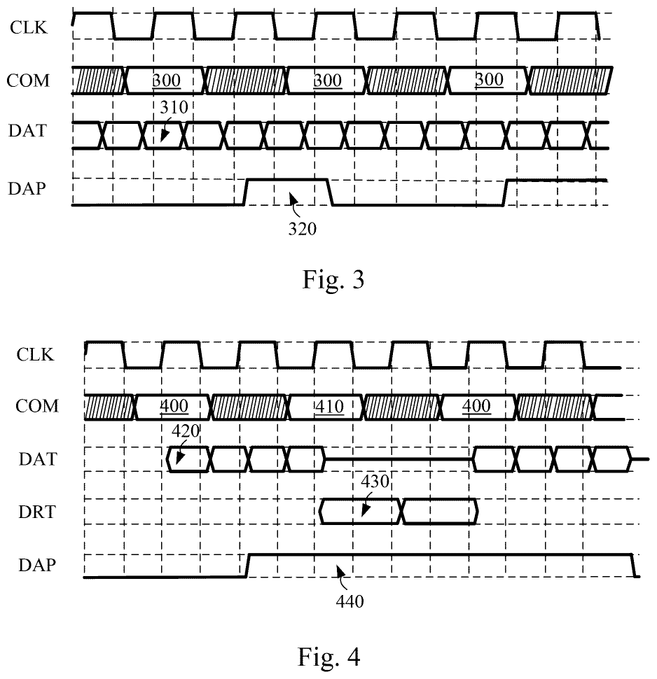

Reference is now made to FIG. 4. FIG. 4 illustrates a timing diagram of signals on a plurality of signal paths related to the operation of the memory controller circuit 120 according to an embodiment of the present invention.

In FIG. 4, besides the clock signal CLK used as a reference of the timing, a command path COM between the command scheduling circuit 250 and the memory circuit 130 that includes the physical layer circuit 240 and a connection wire, a data path DAT between the command scheduling circuit 250 and the memory circuit 130 that includes the physical layer circuit 240 and a connection wire, a data path DRT between the data writing circuit 200 and the data reading circuit 210 that includes a connection wire and a data path DAP between the processor 110 and the data reading circuit 210 that includes a connection wire are in turn illustrated.

FIG. 4 illustrates a scenario that the data hazard condition occurs when the command scheduling circuit 250 performs the data reading operation. Under such a condition, the command scheduling circuit 250 controls the physical layer circuit 240 to perform the data writing on the memory circuit 130. However, corresponding to the time spot that the data reading circuit 210 receives the write data from the data writing circuit 200 in response to the occurrence of the data hazard condition and the performance of the data reading operation, the command scheduling circuit 250 controls the physical layer circuit 240 to perform deselecting on the memory circuit 130 to not transmit the data reading command corresponding to the occurrence of the data hazard condition to the memory circuit 130.

As a result, a deselect 410, also known as a “bubble”, is inserted among a plurality of data reading commands 400 on the command path COM by the command scheduling circuit 250, in which such a blank section is preserved without sending any command. A blank section corresponding to the deselect 410 is presented among the returned data 420 received from the memory circuit 130 on the data path DAT, in which the data path DRT transmits the write data 430 from the data writing circuit 200 to the data reading circuit 210 in such a blank section to avoid the occurrence of the resource conflict. As a result, the data path DAP has the read data 440 continuously received. The data reading operation is not stopped due to the occurrence of the data hazard condition.

Reference is now made to Table 1. Table 1 illustrates a list of efficiency parameters related to the accessing of the memory circuit 130 performed by the memory controller circuit 120 under the conditions that the data forwarding mechanism is not applied and the data forwarding mechanism is applied according to an embodiment of the present invention.

TABLE 1

| | Not applied | Applied | Not applied | Applied |
|---|---|---|---|---|
| Data hazard | 20% | 20% | 50% | 50% |
| rate | | | | |
| Data | 2004.20 | 2936.01 | 1936.49 | 3088.65 |
| bandwidth | | (+31.7%) | | (+37.3%) |
| (MB/second) | | | | |
| Data path | 41.79 | 55.26 | 40.38 | 49.07 |
| usage (%) | | (+13.47%) | | (+8.69%) |
| Average read | 279.82 | 205.00 | 287.42 | 158.04 |
| delay (ns) | | (−26.7%) | | (−45.0%) |
| Number of | 786 | 316 | 884 | 350 |
| read/write | | | | |
| turnaround | | | | |

The statistics of the data hazard rate in the second row of the table is a ratio between the number of the read commands and the write commands having the data hazard occurring and the number of all the commands. According to the statistics of the data bandwidth in the third row of the table, the degree of the increasing of the data bandwidth corresponding to the condition that the data forwarding mechanism is applied relative to the data bandwidth corresponding to the condition that the data forwarding mechanism is not applied becomes higher when the data hazard rate is higher. However, the statistics of the data path usage (a ratio between the time that the data path transmits data and the time of the operation of the whole system) between the command scheduling circuit and the memory circuit in the fourth row of the table shows that the data path usage does not increase since the data forwarding mechanism does not use such a data path. Instead, the data path usage is decreased along with the increasing of the data hazard rate.

On the contrary, the statistics of the average read delay in the fifth row of the table and the statistics of the number of the read/write turnaround in the sixth row of the table show that both the average read delay and the number of the read/write turnaround are decreased due to the application of the data forwarding mechanism. The larger the data hazard rate is, the greater degree of the decreasing of the average read delay and the number of the read/write turnaround are presented.

As a result, the memory controller circuit having the data forwarding mechanism in the present invention receives write data from a data writing circuit as read data when a data hazard condition occurs to avoid the condition that a data reading command is hold in order to process a data writing command first occurs and to avoid a read/write turnaround condition occurs. The delay caused by these conditions can be minimized to improve the read/write efficiency of a memory controller circuit.

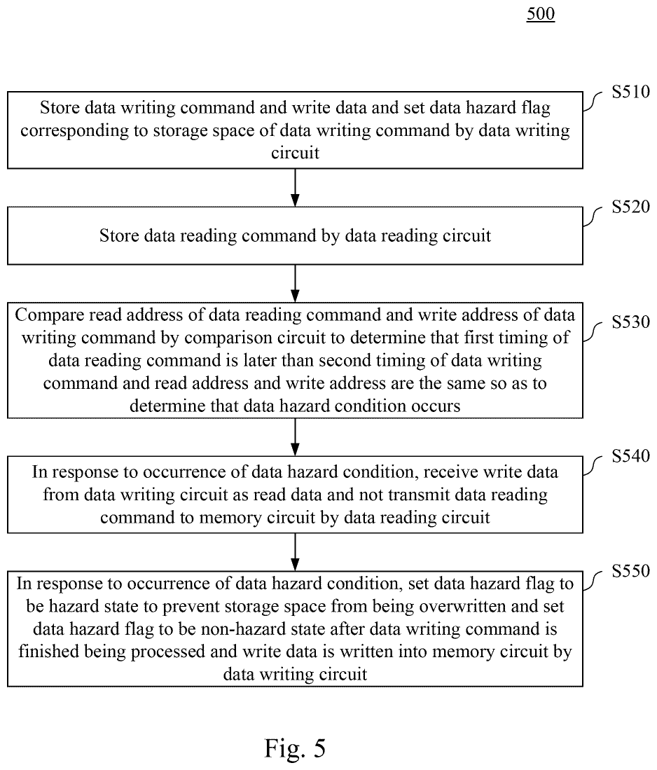

Reference is now made to FIG. 5. FIG. 5 illustrates a flow chart of a memory controller circuit operation method 500 according to an embodiment of the present invention.

In addition to the apparatus described above, the present disclosure further provides the memory controller circuit operation method 500 having the data forwarding mechanism that can be used in such as, but not limited to, the memory controller circuit 120 in FIG. 2A. As illustrated in FIG. 5, an embodiment of the memory controller circuit operation method 500 includes the following steps.

In step S510, the data writing command WDC and write data WDA are stored and the data hazard flag DHF corresponding to the storage space of the data writing command WDC is set by the data writing circuit 200.

In step S520, the data reading command RDC is stored by the data reading circuit 210.

In step S530, the read address of the data reading command RDC and the write address of the data writing command WDC are compared by the comparison circuit 230 to determine that the first timing of the data reading command RDC is later than the second timing of the data writing command WDC and the read address and the write address are the same so as to determine that the data hazard condition occurs.

In step S540, in response to the occurrence of the data hazard condition, the write data WDA is received from the data writing circuit 200 as read data and the data reading command RDC is not transmitted to the memory circuit 130 by the data reading circuit 210.

In step S550, in response to the occurrence of the data hazard condition, the data hazard flag DHF is set to be the hazard state by the data writing circuit 200 to prevent the storage space from being overwritten and the data hazard flag DHF is set to be the non-hazard state by the data writing circuit 200 after the data writing command WDC is finished being processed and the write data WDA is written into the memory circuit 130.

It is appreciated that the embodiments described above are merely an example. In other embodiments, it should be appreciated that many modifications and changes may be made by those of ordinary skill in the art without departing, from the spirit of the disclosure.

In summary, the present invention discloses the memory controller circuit and the memory controller circuit operation method thereof having the data forwarding mechanism to receive write data from a data writing circuit as read data when a data hazard condition occurs to avoid the condition that a data reading command is hold in order to process a data writing command first occurs and to avoid a read/write turnaround condition occurs. The delay caused by these conditions can be minimized to improve the read/write efficiency of a memory controller circuit.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A memory controller circuit configured to access a memory circuit, comprising:
a data writing circuit to store a data writing command and write data and set a data hazard flag corresponding to a storage space of the data writing command;
a data reading circuit to store a data reading command; and
a comparison circuit to compare a read address of the data reading command and a write address of the data writing command to determine that a first timing of the data reading command is later than a second timing of the data writing command and the read address and the write address are the same so as to determine that a data hazard condition occurs;
wherein the data reading circuit, in response to the occurrence of the data hazard condition, receives the write data from the data writing circuit as read data and does not transmit the data reading command to the memory circuit; and
wherein the data writing circuit, in response to the occurrence of the data hazard condition, sets the data hazard flag to be a hazard state to prevent the storage space from being overwritten and sets the data hazard flag to be a non-hazard state after the data writing command is finished being processed such that the write data is written into the memory circuit.

2. The memory controller circuit of claim 1, further comprising:
a physical layer circuit electrically coupled to the memory circuit; and
a command scheduling circuit configured to:
in response to a performance of a data writing operation, perform a data writing on the memory circuit through the physical layer circuit according to the data writing command and the write data of the data writing circuit; and
in response to a performance of a data reading operation, perform a data reading on the memory circuit through the physical layer circuit according to the data reading command of the data reading circuit without the occurrence of the data hazard condition and transmit returned data received from the memory circuit through the physical layer circuit to the data reading circuit.

3. The memory controller circuit of claim 2, further comprising:
a data reading multiplexer electrically coupled to the data writing circuit, the command scheduling circuit and the data reading circuit to select the data writing circuit to receive the write data as the read data in response to the occurrence of the data hazard condition and select the returned data received by the command scheduling circuit from the memory circuit as the read data in response to the non-occurrence of the data hazard condition.

4. The memory controller circuit of claim 2, wherein the data writing circuit further comprises:
a command storage circuit;
a data storage circuit; and
a processing circuit to store the data writing command in the command storage circuit and store the write data in the data storage circuit in response to the receiving of the data writing command and the write data, wherein the storage space is a part of the command storage circuit;
wherein the processing circuit sets the data hazard flag corresponding to the storage space and transmit the data writing command and the write data to the command scheduling circuit in response to the data writing operation performed by the command scheduling circuit.

5. The memory controller circuit of claim 4, wherein the comparison circuit is the processing circuit of the data writing circuit.

6. The memory controller circuit of claim 2, wherein the data reading circuit further comprises:
a command storage circuit;
a data storage circuit; and
a processing circuit to store the data reading command in the command storage circuit in response of the receiving of the data reading command so as to transmit the data reading command to the command scheduling circuit in response to the data writing operation performed by the command scheduling circuit and the non-occurrence of the data hazard condition and to not transmit the data reading command to the command scheduling circuit in response to the occurrence of the data hazard condition;
wherein the processing circuit stores the read data to the data storage circuit in response to the receiving of the read data.

7. The memory controller circuit of claim 2, wherein the command scheduling circuit controls the physical layer circuit to perform deselecting on the memory circuit to not transmit the data reading command to the memory circuit at a time spot that the data reading circuit receives the write data from the data writing circuit in response to the occurrence of the data hazard condition and the performance of the data reading operation.

8. The memory controller circuit of claim 2, wherein the command scheduling circuit keeps controlling the physical layer circuit to perform a data writing on the memory circuit in response to the occurrence of the data hazard condition and the performance of the data writing operation.

9. A memory controller circuit operation method configured to access a memory circuit, comprising:
storing a data writing command and write data and setting a data hazard flag corresponding to a storage space of the data writing command by a data writing circuit;
storing a data reading command by a data reading circuit;
comparing a read address of the data reading command and a write address of the data writing command by a comparison circuit to determine that a first timing of the data reading command is later than a second timing of the data writing command and the read address and the write address are the same so as to determine that a data hazard condition occurs;
in response to the occurrence of the data hazard condition, receiving the write data from the data writing circuit as read data and not transmitting the data reading command to the memory circuit by the data reading circuit; and
in response to the occurrence of the data hazard condition, setting the data hazard flag to be a hazard state to prevent the storage space from being overwritten and setting the data hazard flag to be a non-hazard state after the data writing command is finished being processed and the write data is written into the memory circuit by the data writing circuit.

10. The memory controller circuit operation method of claim 9, further comprising:
in response to a performance of a data writing operation, performing a data writing on the memory circuit through a physical layer circuit electrically coupled to the memory circuit according to the data writing command and the write data of the data writing circuit by a command scheduling circuit; and
in response to a performance of a data reading operation, performing a data reading on the memory circuit through the physical layer circuit according to the data reading command of the data reading circuit without the occurrence of the data hazard condition and transmitting returned data received from the memory circuit through the physical layer circuit to the data reading circuit by the command scheduling circuit.

11. The memory controller circuit operation method of claim 10, further comprising:
selecting the data writing circuit to receive the write data as the read data in response to the occurrence of the data hazard condition and selecting the returned data received by the command scheduling circuit from the memory circuit as the read data in response to the non-occurrence of the data hazard condition by a data reading multiplexer electrically coupled to the data writing circuit, the command scheduling circuit and the data reading circuit.

12. The memory controller circuit operation method of claim 10, further comprising:
storing the data writing command in a command storage circuit comprised by the data writing circuit and store the write data in a data storage circuit comprised by the data writing circuit in response to the receiving of the data writing command and the write data by a processing circuit comprised by the data writing circuit, wherein the storage space is a part of the command storage circuit; and
setting the data hazard flag corresponding to the storage space and transmitting the data writing command and the write data to the command scheduling circuit by the processing circuit in response to the data writing operation performed by the command scheduling circuit.

13. The memory controller circuit operation method of claim 12, wherein the comparison circuit is the processing circuit of the data writing circuit.

14. The memory controller circuit operation method of claim 10, further comprising:
storing the data reading command in a command storage circuit comprised by the data reading circuit in response of the receiving of the data reading command by a processing circuit comprised by the data reading circuit;
transmitting the data reading command to the command scheduling circuit in response to the data writing operation performed by the command scheduling circuit and the non-occurrence of the data hazard condition and not transmitting the data reading command to the command scheduling circuit in response to the occurrence of the data hazard condition by the processing circuit; and
storing the read data to a data storage circuit comprised by the data reading circuit in response to the receiving of the read data by the processing circuit.

15. The memory controller circuit operation method of claim 10, further comprising:
controlling the physical layer circuit to perform deselecting on the memory circuit to not transmit the data reading command to the memory circuit at a time spot that the data reading circuit receives the write data from the data writing circuit by the command scheduling circuit in response to the occurrence of the data hazard condition and the performance of the data reading operation.

16. The memory controller circuit operation method of claim 10, further comprising:
keeping controlling the physical layer circuit to perform a data writing on the memory circuit by the command scheduling circuit in response to the occurrence of the data hazard condition and the performance of the data writing operation.
